(19) United States
(12) Patent Application Publication
(10) Pub. No.: US 2004/0032111 A1
(43) Pub. Date: Feb. 19, 2004

(54) Fifth-wheel latch-release apparatus

(76) Inventor: Steve G. Sanchez, Hollister, CA (US)

Correspondence Address: CENTRAL COAST PATENT AGENCY, PO BOX 187, AROMAS, CA, 95004, US

(21) Appl. No.: 10/615,477

(22) Filed: Jul. 7, 2003

Related U.S. Application Data
(63) Continuation-in-part of application No. 10/223,915, filed on Aug. 19, 2002.

(51) Int. Cl. B62D 53/06; B65G 7/12

(52) U.S. Cl. 280/433; 294/17

(57) ABSTRACT

A latch-release apparatus for use with a fifth-wheel hitch mechanism has a first rigid metal bar having a first end, a second end, and an outside diameter, a metal ring having an inside diameter greater than the outside diameter of the metal bar, surrounding the rigid bar, contacting and welded to the rigid bar between the first and second ends, leaving an open region on a side of the metal bar opposite the weld and a rigid metal hooking rod having a first and a second end, attached by a bent loop on the first end through the open region of the ring welded to the rigid bar, the hooking rod having a bent hook at the second end away from the attachment to the ring welded to the rigid bar, the bent hook for, engaging a fifth-wheel release handle.

### CROSS-REFERENCE TO RELATED DOCUMENTS

The present patent application is a continuation-in-part (CIP) of co-pending U.S. Ser. No. 10/223,915, and claims priority to that application for common disclosure.

### FIELD OF THE INVENTION

The present invention is in the field of trucks and trailers, and pertains more particularly to an apparatus and method for releasing locking mechanisms on truck-and-trailer towing interfaces.

### BACKGROUND OF THE INVENTION

There are many sorts of trailers for transporting cargo and materials, and many sorts of towing vehicles used for towing such trailers. A well-known example is the combination colloquially known as a tractor-trailer rig. In these systems a relatively short tractor, which typically includes a driver's cab and engine compartment, is implemented with one portion of has a standardized hitching mechanism known as a fifth-wheel mechanism. The tractor portion of this mechanism, well-known in the art, is designed to guide a mating latch apparatus on a towed vehicle (a trailer), to support a portion of the weight of the trailer when engaged, and has a spring-loaded latch that makes when the trailer is engaged, and that must be pulled to release the latch so a can be released from the apparatus on the towing vehicle.

FIG. 1 is an overhead plan view of a semi-tractor 101 according to the prior art, having a conventional fifth-wheel apparatus 102. For orientation, the tractor travels forward in the direction of arrow 103. a driver operates in cab 104, and fifth-wheel apparatus 102 is carried on frame members 105 between rear wheel sets 106. In many cases the wheels 106 are covered by fenders attached to frame members 105, which fenders are not shown here to keep the drawing as simple as possible.

Apparatus 102 has a top carrying surface 107 which bears a part of the weight of a trailer, when a trailer is engaged. There is a physically focused opening 108, to aid in the process of backing into a trailer to engage the trailer by the fifth-wheel apparatus, and a latch bar 109 which closes when a trailer is engaged, so the trailer may be towed.

When a trailer is engaged by the fifth-wheel apparatus and has been transported to a destination, it is necessary to release the trailer, for which there is a latch handle 110. Conventionally one reaches under the trailer to grasp handle 110, and pulls the handle to release the latch bar.

Further to the above, in many transport operations, such as moving dirt and rock from construction sites, it is common for a tractor driver to deliver and drop an empty trailer, and to pick up a loaded trailer, several times in a working day. At each transfer, typically drivers and other workers pull the latch handle by hand, by reaching in under the trailer and grasping and pulling the latch, or by looping a rope or cable over and through the latch, and pulling on the rope or cable.

The spring load for these latches is substantial, in part to ensure, that they stay closed during transport of a trailer, and the position of the latch with a trailer on the hitch is inconvenient for manual manipulation. Releasing the latch is not trivial, and can even be dangerous.

What is clearly needed is an apparatus that allows the latch for a fifth-wheel apparatus to be released easily and safely. The present invention, in several embodiments described below in enabling detail accomplishes this purpose.

### SUMMARY OF THE INVENTION

In a preferred embodiment of the present invention a latch-release apparatus for use,with a fifth-wheel hitch mechanism is provided, comprising a first rigid metal bar having a first end, a second end, and an outside diameter, a metal ring having an inside diameter greater than the outside diameter of the metal bar, surrounding the rigid bar, contacting and welded to the rigid bar between the first and second ends, leaving an open region on a side of the metal bar opposite the weld, and a rigid metal hooking rod having a first and a second end, attached by a bent loop on the first end through the open region of the ring welded to the rigid bar, the hooking rod having a bent hook at the second end away from the attachment to the ring welded to the rigid bar, the bent hook for engaging a fifth-wheel release handle.

Also in a preferred embodiment the rigid metal bar is one of a length of steel pipe or a length of aluminum tubing. Still in some preferred embodiments the hooking rod is one of a solid steel rod or a solid aluminum rod. In some embodiments the rigid metal bar and the hooking rod are both steel, and are both zinc-plated. In some embodiments the metal-bar is either powder-coated or painted.

In another aspect of the present invention a release apparatus for use with a fifth-wheel hitch mechanism on a towing vehicle is provided, comprising a first rigid metal bar having a first end, a second end, and an outside diameter, the rigid metal bar attached to a universal joint further attached to a frame member of a vehicle proximate the fifth-wheel mechanism, a metal ring having an inside diameter greater than the outside diameter of the metal bar, surrounding the rigid bar, contacting and welded to the rigid bar between the first and second ends, leaving an open region on a side of the metal bar opposite the weld, and a rigid metal-hooking rod having a first and a second end, attached by a bent loop on the first end through the open region of the ring welded to the rigid bar, the hooking rod having a bent hook at the second end away from the attachment to the ring welded to the rigid bar, the bent hook for engaging a release handle of the fifth-wheel mechanism.

In some embodiments the rigid metal bar is one of a length of steel pipe or a length of aluminum tubing. Also in some embodiments the hooking rod is one of a solid steel rod or a solid aluminum rod. In still other embodiments the rigid metal bar and the hooking rod are both steel, and are both zinc-plated. The rigid metal bar may bee either powder-coated or painted.

In preferred embodiments of the invention taught in the following disclosure in enabling detail, and significantly improved apparatus is provided for safely and effectively decoupling a trailer from a fifth-wheel device.

### BRIEF DESCRIPTION OF THE DRAWINGS FIGURES

FIG. 1 is an overhead plan view of a semi-tractor having a fifth-wheel apparatus in the prior art.

FIG. 2 is a plan view of a release apparatus according to an embodiment of the present invention.

FIG. 3 is an elevation view showing a trailer and a tractor connected, and a release apparatus according to an embodiment of the present invention in use.

FIG. 4 is an illustration of a release apparatus according to an alternative embodiment of the present invention.

FIG. 5 is an illustration of a release apparatus according to yet another alternative embodiment of the present invention.

FIG. 6 is an illustration of a release apparatus according to still another alternative embodiment of the present invention.

FIG. 7 is a perspective view, similar to that of FIG. 3, illustrating a release apparatus assembled to a towing vehicle according to an embodiment of the present invention.

FIG. 8 is an illustration of a release apparatus in yet another preferred embodiment of the present invention.

FIG. 9 is a cross-section of the apparatus of FIG. 8 taken along the line 9-9 of FIG. 8, in the direction of the arrows.

### DESCRIPTION OF THE PREFERRED EMBODIMENTS

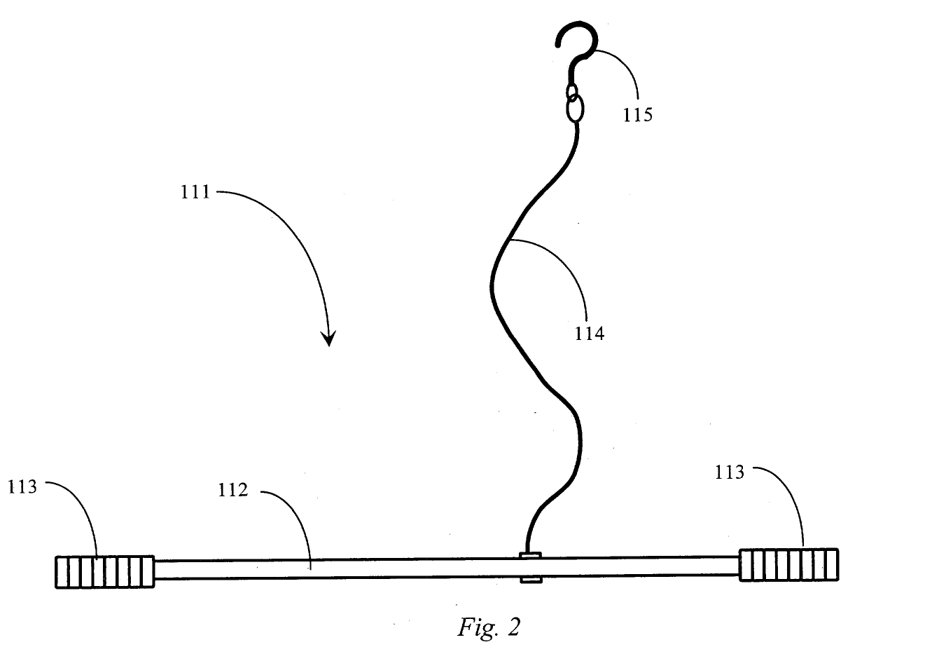

FIG. 2 is a plan view of a release apparatus 111 according to an embodiment of the present invention. Release apparatus 111 in the embodiment shown in FIG. 2 comprises a rigid bar 112, and a flexible tether, in this case a metal cable 114 fixedly attached to the bar, ending in a hook 115. Rigid bar 112 in the embodiment shown is about three feet long, but may in other embodiments have other lengths, and the cable is fixedly attached to the bar at a position in this embodiment about one foot from one end. In other embodiments the cable may be fastened at different points along the bar.

Cable 114 may be, in alternative embodiments, a chain, a rope, or other flexible material. Rigid bar 112 in the embodiment shown is made of schedule 40 steel pipe, but other materials may be used, such as a solid bar, dense plastic, or other kinds of metal bars, either hollow tubing or solid.

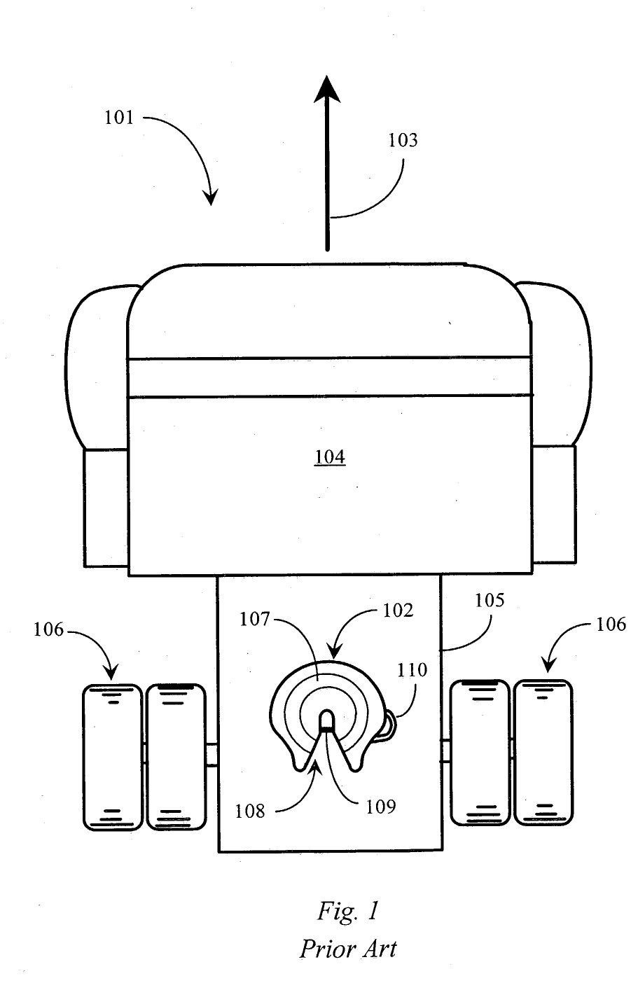

There are a variety of ways the cable or other member 114 may be attached to bar 102, and similarly a variety of ways hook 115 may be securely attached to cable 103. In the embodiment shown in FIG. 1 a stainless steel cable is used, and steel crimps are used to anchor the cable through a hole passing through the bar, and to anchor the cable to itself on the hook end, after passing the cable through an attachment eye of the hook. There are a variety of commercially available hooks that are suitable, and commercially available swage fittings as well for fastening cable. In some cases there may be a roll-up mechanism for the cable or other tether material, such that the cable feeds out as needed from the roll-up mechanism.

In the embodiment illustrated in FIG. 1, for convenience, ease of use, and to protect surfaces that may be engaged, a grip 113, similar to a bicycle handlegrip, is used on both opposite ends of bar 113. In another preferred embodiment a bicycle handlebar grip is used on one end and a rubber cap on the other.

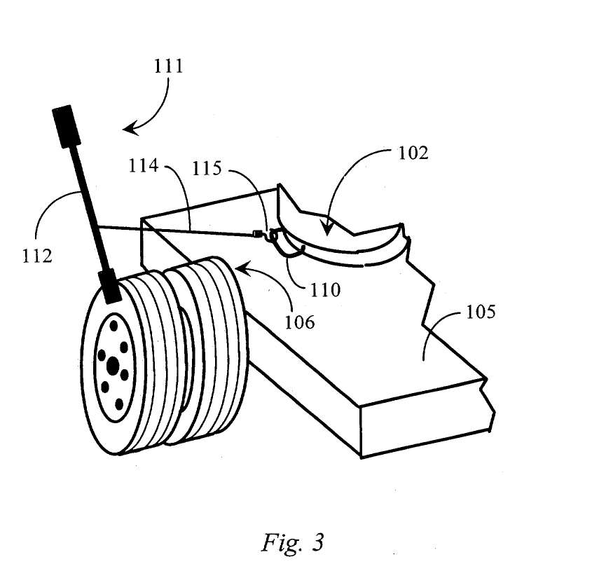

FIG. 3 is a partial perspective view of semi-tractor 101 of FIG. 1 with fifth-wheel apparatus 102 including latch handle 110 showing release apparatus 111 in use according to an embodiment of the present invention. To disengage a trailer from the fifth-wheel apparatus one must engage and pull the handle 110 against spring load. In this embodiment release apparatus 111 is engaged to handle 110 by hook 115. Then one end, typically the shorter end, of bar 112 is placed against one of the tires of the tractor, and the other end is pulled in the direction away from the tire, which urges tension in cable 114 and releases the fifth-wheel apparatus. One grip 113 engages the tire and the other provides a convenient grip for a user's hand.

In the embodiment illustrated with the aid of FIG. 3 release apparatus 111 is carried in the cab of the truck, or in another convenient location, such as in a tool box.

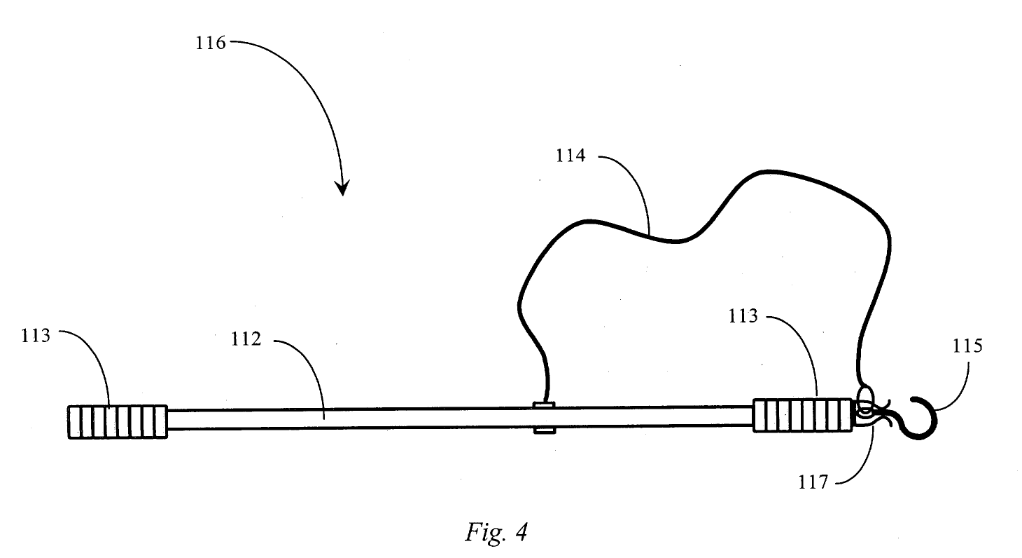

FIG. 4 is an illustration of a release apparatus 116 according to an alternative embodiment of the present invention. Apparatus 116 is in most respects the same as apparatus 11 of FIG. 1, and common elements are numbered the same as in FIG. 1. Apparatus 116 of FIG. 4, however, has a spring clasp 117 fastened to one end of bar 112. The purpose of the spring clasp is to hold hook 115 while the device is not in use, and to allow a user to use bar 112 to extend hook 115 to engage bar 110 without having to reach in under a trailer to do so. Once the hook is engaged, a user may pull on bar 112 to disengage hook 115 from clasp 117, leaving hook 115 engaged with bar 110 (FIG. 3). The user may then use the apparatus just as described above with reference to FIG. 3.

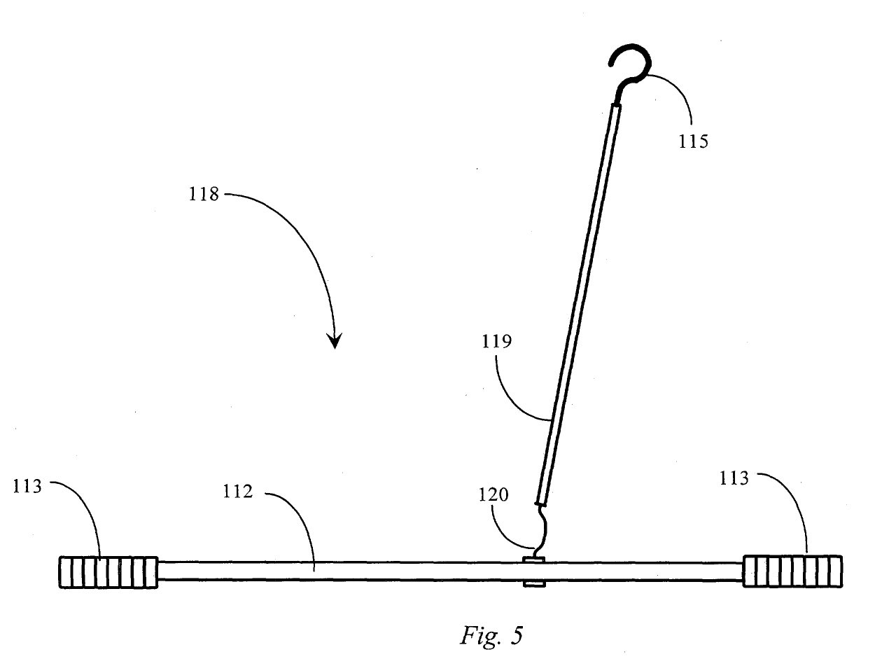

FIG. 5 is an illustration of a release apparatus 118 according to yet another alternative embodiment of the present invention. Again, many of the elements are the same as in earlier-described embodiments, and therefore carry the same element numbers. In apparatus 118 a rigid bar 119 has hook 115 affixed to one end, and the other end tethered by cable 120 to bar 112. A user may use the rigid bar 119 to extend hook 115 to engage handle 110 (FIG. 3), and then use the apparatus as described above with reference to FIG. 3.

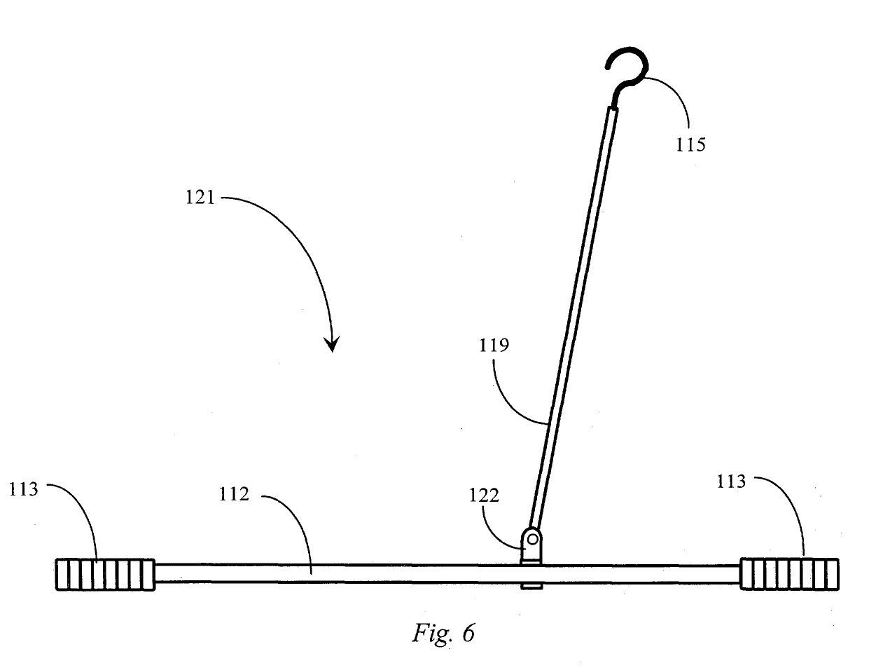

FIG. 6 is an illustration of a release apparatus 121 according to still another alternative embodiment of the present invention. For apparatus 121 rigid bar 119 is attached to bar 112 by a pivot 122, such that bars 112 and 119 may be stored side-by-side (folded parallel), and no cable is needed.

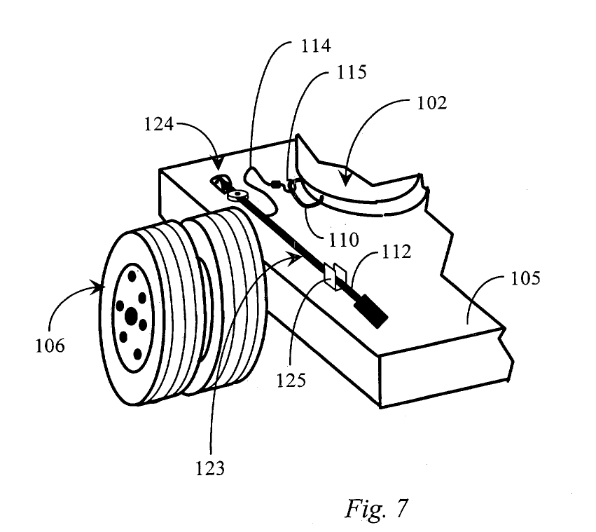

In another aspect of the invention a release apparatus is provided that is a semi-permanent part of the truck or trailer (either one, or possibly both), which makes the apparatus much more accessible and useful. FIG. 7 is a perspective view, similar to that of FIG. 3, illustrating a release apparatus 123 assembled to a towing vehicle. In this embodiment a universal joint 124, which pivots in two directions, is provided and anchored to a frame member 105 of the towing vehicle. Apparatus 123 is mounted pivotally to joint 124 by rigid bar 112 and rests in a snap-n bracket 125 which is also anchored to frame member 105. Cable 114 extends to hook 115, which may in this case be a ring permanently engaged to handle 110. In use, a user grasps bar 112, disengages the release apparatus from bracket 125, rotates the bar upward in universal pivot 124, then pulls bar 112 away from bar 110 to tension cable 114 and release the fifth-wheel mechanism. Once released, the user may replace bar 112 in bracket 125. In this embodiment the release apparatus is always available and ready. In alternative embodiments cable 114 may be exchanged for a rigid bar as in one of the embodiments described above.

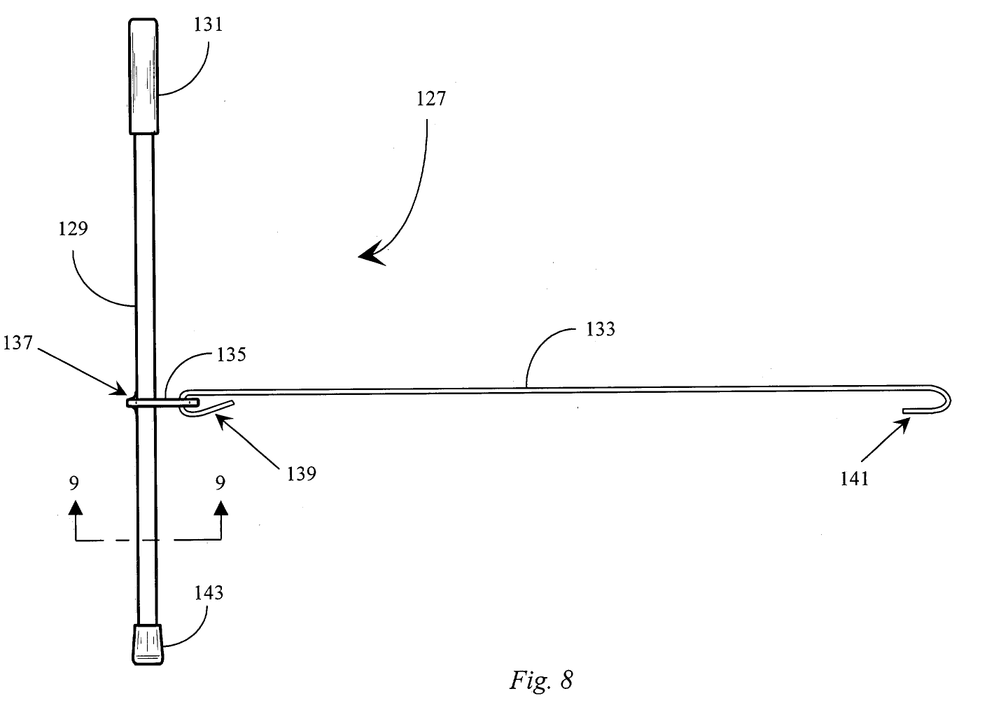

In an alternative preferred embodiment of the invention a release apparatus 127 as shown in FIG. 8 is provided with improvements over the embodiments thus far described. In this new embodiment a bar 129, which may be a solid or a hollow bar, is cut to length from a piece of steel bar, pipe or aluminum tubing. In the case of steel pipe, Schedule 40 pipe of nominal 1 inch diameter has been found to be very adequate. In the case of aluminum tubing, a tubing with a wall thickness somewhat greater than the wall thickness of schedule 40 pipe at 1 inch in diameter. The overall length of pipe 129 in a preferred embodiment is 32 inches, but the length may be a few inches shorter or a few inches longer without effecting operation a great deal.

In this preferred embodiment a steel ring 135 having an original diameter somewhat greater than the diameter of the nominal 1 inch pipe is placed over pipe section 129, at a position to one side of center between the ends of the pipe section, such that there will be a longer end and a shorter end from the ring to each end. This ring is tack-welded to pipe 129, typically both above and below ring 135, as shown in region 137. In a preferred embodiment a ring of nominal 1½ inside diameter and a material diameter of about ¼ inch for the rod used to make the ring. This ring may be a welded ring.

Motivation for placing ring 135 over pipe section 129, such that the ring surrounds the pipe, is to provide a very strong anchor for a hooking rod 133 (see FIG. 8). In this configuration, when the apparatus is in use on a fifth-wheel device, wherein a user may apply considerable force to release a fifth-wheel latch, the ring absorbs all forces rather than the weld. The weld serves only to retain the ring in place to pipe 129, and the weld is not vulnerable to the forces exerted in operation.

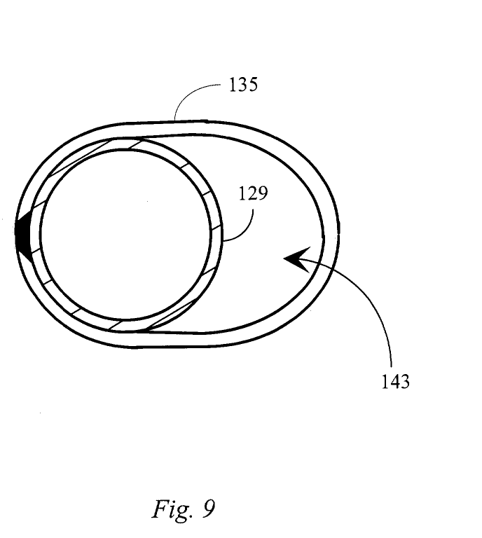

Ring 135 is originally round, rather than oblong as shown in FIG. 9, and after welding is urged into the more oblong shape. This transformation can be by rapping with a mallet with the ring against a rigid surface, or by squeezing the ring with a vise or other apparatus that may span across the diameter of the ring and apply sufficient pressure to reshape the ring. This process allows use of a ring of smaller diameter than would otherwise be needed, and the reshaping provides sufficient area 143 such that hooking rod 133 may be passed through the ring in assembly.

After ring 135 is welded to pipe 129 and reshaped, one end of hooking rod 133, bent to about 180 degrees, is passed through area 143 (FIG. 8), and then bent to close (region 139) such that the hooking rod is captured in the ring. Hooking rod 133 has another 180 degree bent end, opposite the end captured in ring 135, which is used to hook the handle of a fifth-wheel device. The overall length of hooking rod 133, after bending the ends, is about 32 inches in a preferred embodiment, but also may be somewhat shorter and somewhat longer to function properly.

Typically after assembly of hooking rod 133 to the assembly of ring 135 and pipe 129, a foot 143 is added to the shorter end of the apparatus, and a handgrip 131 is added to the longer end. These components are commercially-available components, such as a furniture foot in the first instance, and a bicycle hand grip in the second. The rubber or polymeric foot in use is placed against the rear tire of a tractor, and serves to avoid marking or damaging the tire.

The invention in the various embodiments described thus far above has been described as useful for releasing the fifth-wheel latch on trucks that use fifth-wheel mechanisms. The device of the invention in various embodiments is also useful for operating the tandem handle on the tandem assembly on trailers. In this application the device is used by reversing the placement of the device relative to its use on the fifth-wheel mechanism. That is, the long end is placed against the trailer, and the short end is moved by the user.

It will be apparent to the skilled artisan that there are a variety of alterations that may be made in the embodiments described above without departing from the spirit and scope of the invention. For example, the material of the rigid bars can vary, different sorts and sizes and lengths of cable or other tether material may be used, different kinds of mechanisms may be used for hook 115, different kinds of pivots may be used where needed, and so on. The invention is to be afforded the breadth of the claims which follow.

What is claimed is:

1. A latch-release apparatus for use with a fifth-wheel hitch mechanism, comprising:
a first rigid metal bar having a first end, a second end, and an outside diameter;
a metal ring having an inside diameter greater than the outside diameter of the metal bar, surrounding the rigid bar, contacting and welded to the rigid bar between the first and second ends, leaving an open region on a side of the metal bar opposite the weld; and
a rigid metal hooking rod having a first and a second end, attached by a bent loop on the first end through the open region of the ring welded to the rigid bar, the hooking rod having a bent hook at the second end away, from the attachment to the ring welded to the rigid bar, the bent hook for engaging a fifth-wheel release handle.

2. The apparatus of claim 1 wherein the rigid metal bar is one of a length of steel pipe or a length of aluminum tubing.

3. The apparatus of claim 1 wherein the hooking rod is one of a solid steel rod or a solid aluminum rod.

4. The apparatus of claim 1 wherein the rigid metal bar and the hooking rod are both steel, and are both zinc-plated.

5. The apparatus of claim 1 wherein the rigid metal bar is either powder-coated or painted.

6. A release apparatus for use with a fifth-wheel hitch mechanism on a towing vehicle, comprising:
a first rigid metal bar having a first end, a second end, and an outside diameter, the rigid metal bar attached to a universal joint further attached to a frame member of a vehicle proximate the fifth-wheel mechanism;
a metal ring having an inside diameter greater than the outside diameter of the metal bar, surrounding the rigid bar, contacting and welded to the rigid bar between the first and second ends, leaving an open region on a side of the metal bar opposite the weld; and
a rigid metal hooking rod having a first and a second end, attached by a bent loop on the first end through the open region of the ring welded to the rigid bar, the hooking rod having a bent hook at the second end away from the attachment to the ring welded to the rigid bar, the bent hook for engaging a release handle of the fifth-wheel mechanism.

7. The apparatus of claim 6 wherein the rigid metal bar is one of a length of steel pipe or a length of aluminum tubing.

8. The apparatus of claim 6 wherein the hooking rod is one of a solid steel rod or a solid aluminum rod.

9. The apparatus of claim 6 wherein the rigid metal bar and the hooking rod are both steel, and are both zinc-plated.

10. The apparatus of claim 6 wherein the rigid metal bar is either powder-coated or painted.
